(19) United States
(12) Patent Application Publication
(10) Pub. No.: US 2022/0129814 A1
(43) Pub. Date: Apr. 28, 2022

(54) METHOD FOR AUTOMATICALLY EXTRACTING VEHICLE GETTING-ON-AND-OFF PLACES AND OPERATION SERVER UTILIZING THE SAME

(71) Applicants: Hyundai Motor Company, Seoul (KR); Kia Corporation, Seoul (KR)

(72) Inventors: Younghyun JU, Whasung-Si (KR); Soo Young Kim, Whasung-Si (KR); Gi Seok Park, Whasung-Si (KR); Jonghoon Kim, Whasung-Si (KR); Kyoung Enn Min, Whasung-Si (KR); Hyungu Roh, Whasung-Si (KR); Hee Su Shin, Whasung-Si (KR); SungEun Kim, Whasung-Si (KR); Minwoo Kwak, Whasung-Si (KR)

(73) Assignees: Hyundai Motor Company, Seoul (KR); Kia Corporation, Seoul (KR)

(21) Appl. No.: 17/242,482

(22) Filed: Apr. 28, 2021

(30) Foreign Application Priority Data
Oct. 27, 2020 (KR) 10-2020-0140123

(51) Int. Cl. G06Q 10/06; H04L 29/08; G08G 1/01; G06Q 50/26; G01C 21/34

(52) U.S. Cl. CPC G06Q 10/06315; H04L 67/12; G06Q 50/30; G06Q 50/26; G01C 21/3461; G08G 1/0137

(57) ABSTRACT

A method for extracting a get-on-and-off place where a vehicle may stop, which is performed by an operation server, includes, extracting vehicle road sections accessible by foot, filtering the extracted road sections by excluding a road section in which stopping of the vehicle is not permitted under traffic regulations, from the extracted road sections, selecting n quantity of virtual get-on-and-off places allowing getting on-and-off from the filtered roads, determining the walking time from each in all points of the service area to closest get-on-and-off place point, setting a longest time among walking times of all points of the service area, as a maximum walking time, and select a predetermined quantity of virtual get-on-and-off places from among the n quantity of virtual get-on-and-off places such that the selected maximum walking time is minimum, where the quantity k may be a natural number smaller than number n.

### CROSS-REFERENCE TO RELATED APPLICATION

The present application claims priority to Korean Patent Application No. 10-2020-0140123 filed on Oct. 27, 2020, the entire contents of which is incorporated herein for all purposes by this reference.

### BACKGROUND OF THE INVENTION

### Field of the Invention

The present invention relates to a method for automatically extracting a vehicle get-on-and-off place and an operation server utilizing the same.

### Description of Related Art

In a ridesharing service, when a user willing to use a vehicle designates a get-on position, the user may designate the user's current position as the get-on position only in consideration of the user's convenience. Accordingly, the get-on position may be designated in an area where parking and stoppage is prohibited, or in an area where it is difficult for a vehicle to enter. In the instant case, it may cause inconvenience to other vehicles, while the user himself may also experience an obstacle in using the vehicle. The same problem may arise when the user designates such a place to be a destination for get-off place.

Meanwhile, if the get-on place and get-off place are too far from the user's current position and destination, the user willing to use the service may experience discomfort, and the convenience and effectiveness aimed by the ridesharing service may deteriorate.

In operating vehicles for ridesharing, candidate get-on places and candidate get-off places where passengers may get on or off the vehicle may be set in advance. In the case of generating the candidate get-on places and the candidate get-off places every time when there is a user's vehicle call, the time required to prepare transportation service increases, so it is difficult to dispatch and send the vehicle within the time required by the user.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a method for automatically extracting a vehicle get-on-and-off place and an operation server utilizing the same.

An exemplary operation server may include a road section extraction module configured to extract vehicle road sections accessible by foot, a filtering module configured to filter extracted road sections by excluding a road section in which stopping of the vehicle is not permitted under traffic regulations, from the extracted road sections, and a candidate get-on-and-off place selection module configured to select an n quantity of virtual get-on-and-off places allowing getting on-and-off from filtered roads, determine a walking time from each in all points of a service area to a closest get-on-and-off place point, set a longest time among walking times of the all points of the service area, as a maximum walking time, and select a predetermined quantity of virtual get-on-and-off places from among the n quantity of virtual get-on-and-off places by use of the selected maximum walking time,

The predetermined quantity may be a natural number smaller than number n.

The candidate get-on-and-off place selection module may be configured to, generate all combinations that are made by selecting the predetermined k quantity of virtual get-on-and-off places from among the n quantity of virtual get-on-and-off places, determine a plurality of maximum walking times with respect to the all combinations, select a combination having a minimum walking time from among the plurality of maximum walking times, and select the k quantity of virtual get-on-and-off places of a selected combination as candidate get-on-and-off places.

The candidate get-on-and-off place selection module may be configured to, with respect to all of the n quantity of virtual get-on-and-off places, set a maximum value among a plurality of minimum walking times with respect to all points within the service area when excluding one virtual get-on-and-off place from the n quantity of virtual get-on-and-off places, as the maximum walking time, to generate n quantity of maximum walking times, and exclude an excluded virtual get-on-and-off place corresponding to a minimum value of the n quantity of maximum walking times.

The candidate get-on-and-off place selection module may be configured to exclude the virtual get-on-and-off place and subtract 1 from the number n.

The candidate get-on-and-off place selection module may be configured to repeat, until the number n reaches a predetermined k quantity, with respect to all of the n quantity of virtual get-on-and-off places, set a maximum value among a plurality of minimum walking times with respect to all points within the service area when excluding one virtual get-on-and-off place from the n quantity of virtual get-on-and-off places, as the maximum walking time, to generate n quantity of maximum walking times, and finally exclude the excluded virtual get-on-and-off place corresponding to the minimum value of the n quantity of maximum walking times.

The candidate get-on-and-off place selection module may be configured to, when determining the n quantity of walking travel times from each in the all points within the service area to the n quantity of virtual get-on-and-off places, decrease the walking travel time with respect to a virtual get-on-and-off place satisfying a predetermined condition according to a predetermined weight value.

The predetermined condition may include whether a point of interest (POI) is adjacent to the virtual get-on-and-off place.

The candidate get-on-and-off place selection module may be configured to, set a maximum value among a plurality of minimum walking times with respect to all points within the service area when excluding one virtual get-on-and-off place from the n quantity of virtual get-on-and-off places, as the maximum walking time, and exclude the excluded one virtual get-on-and-off place, and subtract 1 from the number n when the maximum walking time does not exceed a predetermined threshold walking time.

The candidate get-on-and-off place selection module may be configured to, when the maximum walking time is longer than the predetermined threshold walking time, select the n quantity of virtual get-on-and-off places including the excluded one virtual get-on-and-off place, as the candidate get-on-and-off places.

An exemplary method for extracting a get-on-and-off place where a vehicle may stop, which is performed by an operation server, may include, extracting vehicle road sections accessible by foot, filtering extracted road sections by excluding a road section in which stopping of the vehicle is not permitted under traffic regulations, from the extracted road sections, selecting n quantity of virtual get-on-and-off places allowing getting on-and-off from filtered roads, determining a walking time from each in all points of a service area to a closest get-on-and-off place point, setting a longest time among walking times of all points of the service area, as a maximum walking time, and select a predetermined quantity of virtual get-on-and-off places from among the n quantity of virtual get-on-and-off places such that the selected maximum walking time is minimum,

The predetermined quantity may be a natural number smaller than number n.

The selecting of the predetermined k quantity of virtual get-on-and-off places may include, generating all combinations which may include selecting k items from among the n quantity of virtual get-on-and-off places, determining a plurality of maximum walking times with respect to the all combinations, selecting a combination having a minimum walking time from among the plurality of maximum walking times, and selecting the k quantity of virtual get-on-and-off places of the selected combination as candidate get-on-and-off places.

The selecting of the k quantity of virtual get-on-and-off places may include, setting a maximum value among a plurality of minimum walking times with respect to all points within the service area when excluding one virtual get-on-and-off place from the n quantity of virtual get-on-and-off places, as the maximum walking time, to generate n quantity of maximum walking times, with respect to all of the n quantity of virtual get-on-and-off places, and finally excluding the excluded virtual get-on-and-off place corresponding to a minimum value of the n quantity of maximum walking times.

An exemplary method may further include excluding the virtual get-on-and-off place and subtracting 1 from the number n.

The setting of the maximum value among a plurality of minimum walking times with respect to all points within the service area when excluding one virtual get-on-and-off place from the n quantity of virtual get-on-and-off places, as the maximum walking time, to generate n quantity of maximum walking times, with respect to all of the n quantity of virtual get-on-and-off places, and the finally excluding of the excluded virtual get-on-and-off place corresponding to the minimum value of the n quantity of maximum walking times are repeated until the number n reaches k.

The selecting of the k quantity of virtual get-on-and-off places may further include, when determining the n quantity of walking travel times from each in the all points within the service area to the n quantity of virtual get-on-and-off places, decreasing the walking travel time with respect to a virtual get-on-and-off place satisfying a predetermined condition according to a predetermined weight value.

The predetermined condition may include whether a point of interest (POI) is adjacent to the virtual get-on-and-off place.

An exemplary method may further include, setting a maximum value among a plurality of minimum walking times with respect to all points within the service area when excluding one virtual get-on-and-off place from the n quantity of virtual get-on-and-off places, as the maximum walking time, and finally excluding the excluded one virtual get-on-and-off place, and subtract 1 from the number n when the maximum walking time does not exceed a predetermined threshold walking time.

An exemplary method may further include, when the maximum walking time is longer than the predetermined threshold walking time, selecting the n quantity of virtual get-on-and-off places including the excluded one virtual get-on-and-off place, as candidate get-on-and-off places.

Various aspects of the present invention provide a method for automatically extracting a vehicle get-on-and-off place and an operation server utilizing the same.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a passenger transportation service system according to an exemplary embodiment of the present invention.

FIG. 2 is a flowchart showing a method for determining vehicle get-on-and-off places according to an exemplary embodiment of the present invention.

FIG. 3 schematically illustrates an operation server according to an exemplary embodiment of the present invention.

FIG. 4 illustrates a method for extracting a candidate get-on-and-off place according to an exemplary embodiment of the present invention.

FIG. 5 is a flowchart showing a method for extracting an optimal get-on-and-off place according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments included in the present specification will be described in detail with reference to the accompanying drawings. In the present specification, the same or similar components will be denoted by the same or similar reference numerals, and a repeated description thereof will be omitted. Terms “module” and/or “unit” for components used in the following description are used only to easily describe the specification. Therefore, these terms do not have meanings or roles that distinguish them from each other in and of themselves. In describing exemplary embodiments of the present specification, when it is determined that a detailed description of the well-known art associated with the present invention may obscure the gist of the present invention, it will be omitted. The accompanying drawings are provided only to allow exemplary embodiments included in the present specification to be easily understood and are not to be interpreted as limiting the spirit included in the present specification, and it is to be understood that the present invention includes all modifications, equivalents, and substitutions without departing from the scope and spirit of the present invention.

Terms including ordinal numbers such as first, second, and the like will be used only to describe various components, and are not to be interpreted as limiting these components. The terms are only used to differentiate one component from other components.

It is to be understood that when one component is referred to as being “connected” or “coupled” to another component, it may be connected or directly coupled to the other component or may be connected or coupled to the other component with a further component intervening therebetween. Furthermore, it is to be understood that when one component is referred to as being “directly connected” or “directly coupled” to another component, it may be connected or directly coupled to the other component without a further component intervening therebetween.

It will be further understood that terms “comprise” and “have” used in the exemplary embodiment specify the presence of stated features, numerals, steps, operations, components, parts, or combinations thereof, but do not preclude the presence or addition of one or more other features, numerals, steps, operations, components, parts, or combinations thereof.

Furthermore, the terms “-er”, “-or”, and “module” described in the specification mean units for processing at least one function and operation, and may be implemented by hardware components or software components, and combinations thereof.

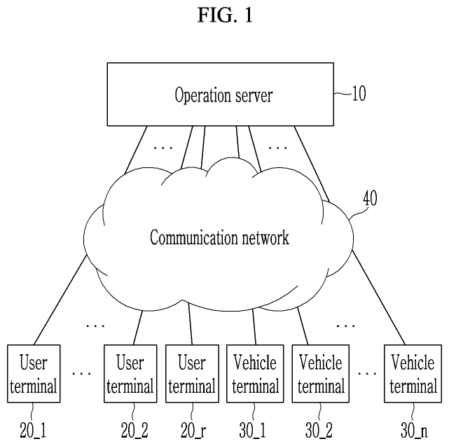

FIG. 1 illustrates a passenger transportation service system according to an exemplary embodiment of the present invention.

A passenger transportation service system 1 includes an operation server 10, user terminals 20_1 to 20_r, and vehicle terminals 30_1 to 30_n. Here, r and n are natural numbers greater than or equal to 1.

Each of the vehicles providing the passenger transportation service is provided with a vehicle terminal, and FIG. 1 illustrates that n vehicles are providing the passenger transportation service, and r user terminals may generate a vehicle call request, i.e., a request for calling a vehicle. Hereinafter, for convenience of description, when a feature applicable to any user terminal is described, the user terminal is referred to by the reference numeral 20, and when a feature applicable to any vehicle terminal, the vehicle terminal is referred to by the reference numeral 30, while the reference numeral 20_j is used to indicate a specific user terminal and the reference numeral 30_i is used to indicate a specific vehicle terminal.

Transmission and reception of information between the user terminal 20 and the operation server 10 and transmission and reception of information between the vehicle terminal 30 and the operation server 10 may be conducted through a communication network 40.

A user (hereinafter, also called a passenger) willing to use the passenger transportation service may input information associated to destination and position information related to the user into the user terminal 20, and the user terminal 20 may transmit the input data to the operation server 10. The position information related to the user may be based on a currently recognized position utilizing a global positioning system (GPS) of the user terminal 20. Alternatively, the position information related to the user may be information associated with a position which the user specifies through the user terminal 20.

The user terminal 20 may be inputted with a vehicle call, a destination, and an origin from the passenger, and may transmit the destination and the origin together with notification of the vehicle call to the operation server 10. The origin may be a current position of the user terminal 20, and the current position may be recognized using the Global Positioning System (GPS) of the user terminal 20. Furthermore, the user terminal 20 may transmit the number of passengers, etc. along with the origin and the destination to the operation server 10.

The user terminal 20 may receive information related to a get-on place and a get-off place from the operation server 10. The user terminal 20 may receive information from the operation server 10, such as a vehicle identification number, a vehicle driver's contact information, an expected arrival time of the vehicle to the get-on place (hereinafter, an expected get-on time), an expected arrival time of the vehicle to the get-off place (hereinafter, an expected get-off time), etc., along with the get-on place and the get-off place.

The user terminal 20 may receive charging information for a transportation service fare from the operation server 10 and pay the fare based on the charging information. The user terminal 20 may receive identification information for identifying a passenger from the operation server 10 through the communication network 40, and may display the identification information on a display of the user terminal 20.

The user terminal 20 may be a smart phone, a laptop, a tablet PC, etc., and an application to use the passenger transportation service may be provided in the user terminal 20. The user terminal 20 may perform the aforementioned operations through the provided application.

The vehicle terminal 30 is provided in each of the vehicles used in the passenger transportation service. The vehicle terminal 30 may transmits a current position of the vehicle to the operation server 10 in real time, and may receive, from the operation server 10, information related to the get-on place and the get-off place with respect to each passenger to use the vehicle and information related to an expected get-on time for each get-on place and an expected get-off time for each get-off place. The vehicle terminal 30 may also receive an identification information for each passenger to use the vehicle from the operation server 10. The identification information for each passenger may be transmitted from the operation server 10 to both of the user terminal 20 of each passenger and the vehicle terminal 30 of the vehicle to be used by each passenger.

The vehicle terminal 30 may be a smart phone, a laptop, a tablet PC, etc., and an application for providing the passenger transportation service may be installed in the vehicle terminal 30. The vehicle terminal 30 may perform the aforementioned operations through the installed application.

The operation server 10 receives information for the origin, departure time, and the destination from the user terminal 20, and selects, among vehicles configured for providing the passenger transportation service, a vehicle to pass through the get-on place corresponding to the origin received from the user terminal 10 and the get-off place corresponding to the destination.

The operation server 10 may transmit the get-on place and the get-off place, the expected get-on time and the expected get-off time, and passenger identification information, to the vehicle terminal 30_i (here, i is a natural number from in 1 to n) of the selected vehicle, and to the user terminal 20_j (here, j is a natural number from 1 to r) that requested the vehicle call. Furthermore, the operation server 10 may further transmit the vehicle identification number, the vehicle driver's contact information, charging information to the user terminal 20_j, and the like.

Furthermore, the user terminal 20 may further perform an operation required to request the passenger transportation service, if applicable. The vehicle terminal 30 may further perform an operation required to provide the passenger transportation service, if applicable. The operation server 10 may provide a further service to the user terminal 20 or the vehicle terminal 30, if applicable. The content described in various exemplary embodiments of the present invention does not limit the application of the technology not described to the present invention. That is, a new service may be provided by combining the present invention with currently known technologies, and the contents described in various exemplary embodiments of the present invention do not limit such variation.

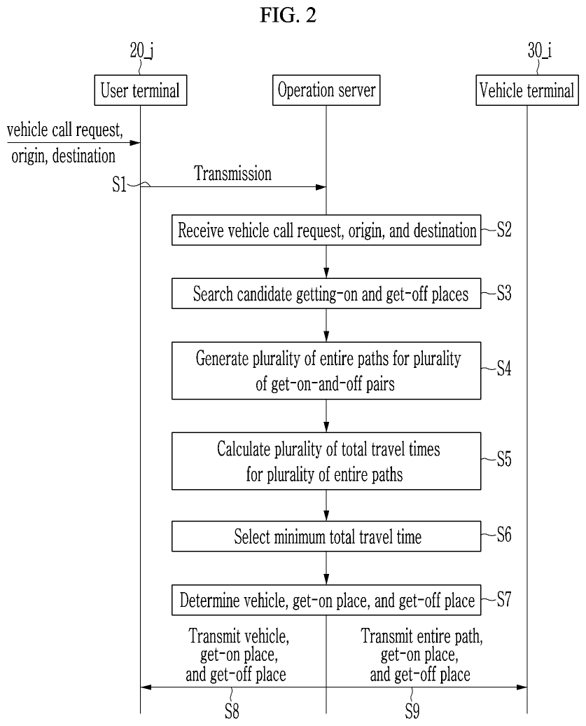

FIG. 2 is a flowchart showing a method for determining vehicle get-on-and-off places according to an exemplary embodiment of the present invention.

First at step S1, the user terminal 20 receives the vehicle call request from the passenger along with the origin and the destination, and transmits the vehicle call request to the operation server 10 along with information for the origin and the destination.

Subsequently at step S2, the operation server 10 receives the origin, the destination, and the vehicle call request from the user terminal 20.

Subsequently at step S3, the operation server 10 searches for a candidate get-on place and a candidate get-off place for get-on and get-off around the origin and the destination. The operation server 10 may search for the candidate get-on place within a predetermined distance from the origin based on a straight-line distance, a walking distance, a walking time, and the like from the origin, and may search for the candidate get-off place within a predetermined distance with respect to the destination based on a straight-line distance, a walking distance, a walking time, and the like to the destination.

At step S4, the operation server 10 generates a plurality of get-on-and-off place pairs by combining each in a plurality of candidate get-on places and each in a plurality of candidate get-off places, and generates an entire path for each in the plurality of get-on-and-off place pairs. At the instant time, when two or more user terminals are involved, the operation server 10 finds, based on the origin and the destination received from each user terminal, the plurality of candidate get-on places and the plurality of candidate get-off places, generates the plurality of get-on-and-off place pairs for each user terminal, and selects one from the plurality of get-on-and-off place pairs for each user terminal, to generate an entire path with respect to a plurality of user terminals. The operation server 10 generates a plurality of entire paths for all combinations available by selecting one from the plurality of get-on-and-off place pairs for each in the plurality of user terminals. Furthermore, when a plurality of vehicles is available for the transportation service, the operation server 10 generates the plurality of entire paths for each in the plurality of vehicles in the same way as described above.

At step S5, the operation server 10 determines a plurality of total travel times with respect to the plurality of entire paths. The total travel time may be determined in consideration of a first walking distance from the origin to the candidate get-on place, a second walking distance from the candidate get-off place to the destination, a first walking time required to walk the first walking distance, a second walking time required to walk the second walking distance, a vehicle travel time for the vehicle to move from the origin to the destination, the passenger's preference based on the passenger's profile and the situation in which the transportation service is provided, the vehicle running time, an existing passenger's detour cost in the case that shared ride is available, and the like. Furthermore, when a plurality of vehicles is available for the transportation service, the operation server 10 determines the plurality of total travel times for each in the plurality of vehicles in the same way as described above.

The operation server 10 determines a passenger moving time for each in the plurality of entire paths. The operation server 10 determines a plurality of passenger moving times for all the plurality of entire paths by use of map information and traffic situation information, and the like. The passenger moving time includes, the first walking distance from the origin to the candidate get-on place, the second walking distance from the candidate get-off place to the destination, the first walking time required to walk the first walking distance, the second walking time required to walk the second walking distance, and the vehicle travel time for the vehicle to move from the candidate get-on place to the candidate get-off place. When a plurality of vehicle call requests, a plurality of origins, and a plurality of destinations are received from the plurality of user terminals, the operation server 10 determines the passenger moving time for each in the plurality of user terminals, and determines the passenger moving time with respect to the one entire path by summing the plurality of passenger moving times with respect to the plurality of user terminals, according to one in the plurality of entire paths. Furthermore, when a plurality of vehicles is available for the transportation service, the operation server 10 determines the plurality of passenger moving times for each in the plurality of vehicles in the same way as described above.

The operation server 10 determines the vehicle running time in consideration of the total running time, fuel cost, and the like of the vehicle, for each in the plurality of entire paths. The vehicle running time corresponds to a running cost of the vehicle, and the operation server 10 may generate the vehicle running time by converting the vehicle running cost for each in the plurality of entire paths to time. The operation server 10 may determine a plurality of vehicle running times with respect to all of the plurality of entire paths. For example, the vehicle running time determination module 120 may determine the vehicle running time by adding the total running time for which the vehicle travels to provide the transportation service to the time converted from the fuel consumed by running of the vehicle, for one in the plurality of entire paths. Furthermore, when a plurality of vehicles is available for the transportation service, the operation server 10 determines the plurality of vehicle running times for each in the plurality of vehicles in the same way as described above.

In determining the total travel time, in the case that a shared ride of the vehicle is available, the operation server 10 may consider a detour time of the existing passengers and a detour time according to the detour distance, according to the addition of the candidate get-on place and the candidate get-off place. The operation server 10 adds all of a plurality of vehicle travel times according to the plurality of vehicle call requests, through which the detour time of the existing passengers due to shared riding may be reflected. All the vehicle travel time for each passenger are summed in determining the passenger moving time. However, the vehicle actually travels according to the entire path, and therefore, the result of sum of all the vehicle travel time for each passenger may be different from an actual travel time for the vehicle travel to transport the passengers. That is, in the passenger moving time, there is a time overlap between the vehicle travel time for each passenger. As the number of passengers increases due to shared riding, the number of the vehicle travel times increases in determining the passenger moving time, resulting in more time overlap. Through this, the detour time, the detour distance, and the like of the existing passengers may be reflected in the passenger moving time.

The operation server 10 may determine the total travel time in consideration of the passenger's preference based on the passenger's profile and the situation in which the transportation service is provided along with the passenger moving time and the vehicle running time for each in the plurality of entire paths. The situation in which the transportation service is provided includes the day of the week, time, weather, and the like, and the passenger's profile includes the gender, age group of the passenger, and the like. For example, the operation server 10 may set a higher preference for the candidate get-on place and the candidate get-off place which may provide a shorter walking time or availability of moving through buildings in rainy weather. Optionally, the operation server 10 may set a higher preference for the candidate get-on place and the candidate get-off place on a wider street in the case of a female passenger during the late night. The higher the preference, the higher the weight value for the factor in determining the total travel time. Furthermore, when a plurality of vehicles is available for the transportation service, the operation server 10 determines the plurality of total travel times for each in the plurality of vehicles in the same way as described above.

At step S6, the operation server 10 may select a minimum total travel time from among the plurality of total travel times with respect to the plurality of entire paths of the plurality of vehicles. The operation server 10 stores the plurality of total travel times with respect to the plurality of entire paths with respect to each in the plurality of vehicles. The operation server 10 selects the minimum total travel time from among all the plurality of total travel times with respect to the plurality of vehicles.

At step S7, the operation server 10 finally determines, a vehicle to run an entire path corresponding to the selected total travel time, the candidate get-on place included in the corresponding entire path, and the candidate get-off place included in the corresponding entire path, as the vehicle to transport the passenger, the get-on place for each passenger to get on the vehicle, and the get-off place for each passenger to get off the vehicle.

At step S8, the operation server 10 may transmit the determined vehicle, each get-on place, and each get-off place, to each user terminal 20_j. Accordingly, at step S9, the operation server 10 may transmit information related to the entire path and the get-on place and get-off place for each passenger to the vehicle terminal 30_i of the determined vehicle.

The candidate get-on-and-off places for the origin and the destination received from the user terminal 20 are preset in the operation server 10. The operation server 10 may preset the candidate get-on-and-off places for every point of a service area for the transportation service, in consideration of distances from each point to get-on-and-off points where the vehicle may stop. In the instant case, the quantity of candidate get-on-and-off places may be limited to a predetermined quantity (hereinafter, maximum quantity of get-on-and-off places, k).

Among candidate get-on-and-off places, those adjacent to the origin become candidate get-on places, and those adjacent to the destination become candidate get-off places. Among the plurality of candidate get-on-and-off places where the vehicle may stop, the operation server 10 may find the candidate get-on-and-off place close to the origin as the candidate get-on place, and may find the candidate get-on-and-off place close to the destination as the candidate get-on place.

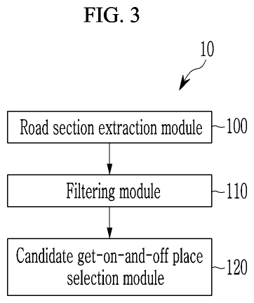

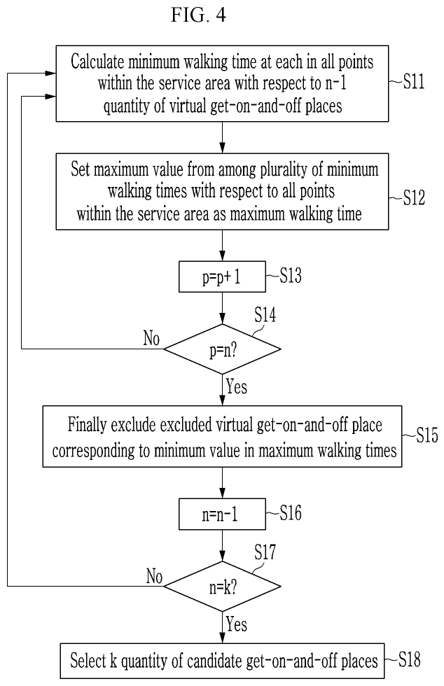

Hereinafter, a method for generating the candidate get-on-and-off places is described in detail with reference to FIG. 3 and FIG. 4.

FIG. 3 schematically illustrate an operation server according to an exemplary embodiment of the present invention.

The operation server 10 includes a road section extraction module 100, a filtering module 110, and a candidate get-on-and-off place selection module 120. FIG. 3 merely illustrates constituent elements required for various exemplary embodiments of the present invention, and the operation server 10 may include further constituent element.

The road section extraction module 100 extracts vehicle road sections accessible by foot. Through road property information in vehicle road network data, the road section extraction module 100 may extract the vehicle road sections accessible by foot by utilizing the connection information between the pedestrian network and the vehicle road in the service area, excluding vehicle-only roads, overpasses, underground roads, and the like from entire roads within the service area.

The filtering module 110 performs filtering to exclude sections in which stopping of the vehicle is not permitted under traffic regulations, from the extracted road sections. For example, crosswalks, fire hydrants, around bus stops, and the like are sections where stopping is not permitted due to traffic regulations. Furthermore, the filtering module 110 may perform filtering to exclude sections in which obstacles that physically obstruct road access are installed in the extracted road sections. For example, roads with fences or other obstacles installed along roads are excluded from the extracted road sections.

The candidate get-on-and-off place selection module 120 selects all virtual get-on-and-off places allowing getting on-and-off from the filtered roads, and when the quantity of all virtual get-on-and-off places less than or equal to k, selects all virtual get-on-and-off places as candidate get-on-and-off places. When the quantity n (a natural number greater than or equal to 1) of all virtual get-on-and-off places is greater than k, the candidate get-on-and-off place selection module 120 selects k items from among the n quantity of virtual get-on-and-off places as the candidate get-on-and-off places.

In more detail, the candidate get-on-and-off place selection module 120 selects k items whose maximum walking time is minimum, from among the n quantity of virtual get-on-and-off places. When determining the walking time, map information in the service area may be used. The candidate get-on-and-off place selection module 120 determines the walking time from each in all points of the service area to a closest get-on-and-off place point, and sets the maximum walking time as a longest time among the determined walking times.

Ideally, all points in the service area mean all points where a passenger may be positioned in the service area. In various exemplary embodiments of the present invention, the candidate get-on-and-off place selection module 120 may set all points in the service area by extracting points separated with a predetermined distance (e.g., 10 m) from a road that people may pass.

First, the candidate get-on-and-off place selection module 120 generates all combinations that may be made by selecting k items from among the n quantity of virtual get-on-and-off places. The number of all combinations may be determined nCk.

For each in all combinations nCk, the candidate get-on-and-off place selection module 120 determines a plurality of maximum walking times max_wi (here, i is in a range from 1 to nCk), select a combination having a minimum walking time from among the plurality of maximum walking times, and select k quantity of virtual get-on-and-off places of the corresponding combination as the candidate get-on-and-off places.

Since the number of all combinations is nCk, when n is large, the amount of computation for the candidate get-on-and-off place selection module 120 to select k quantity of candidate get-on-and-off places out of n items may be very large.

Accordingly, the candidate get-on-and-off place selection module 120 may use a heuristic method when n is greater than a predetermined threshold value.

FIG. 4 illustrates a method for extracting a candidate get-on-and-off place according to an exemplary embodiment of the present invention.

For example, at step S11, the candidate get-on-and-off place selection module 120 determines the minimum walking time from each in all points within the service area, with respect to n-1 quantity of virtual get-on-and-off places obtained by excluding one from the n quantity of virtual get-on-and-off places. The candidate get-on-and-off place selection module 120 may determine n-1 quantity of walking travel times from each in all points within the service area to the n-1 quantity of virtual get-on-and-off places, and may detect the minimum walking time from the determined n-1 quantity of walking travel times. Accordingly, the minimum walking times are determined for each in all points within the service area.

At step S12, the candidate get-on-and-off place selection module 120 sets a maximum value among a plurality of minimum walking times with respect to all points within the service area, as the maximum walking time.

The candidate get-on-and-off place selection module 120 repeats the steps of S11 and S12 with respect to all of the n quantity of virtual get-on-and-off places.

For example, at step S13 subsequent to the step S12, count value p counting the number of repetitions is increased by one.

At step S14, it is determined whether the count value p is equal to n. When the count value p has not reached n (S14-No), the steps S11 and S12 are repeated, when n is reached (S14-Yes), the repetition of the steps S11 and S12 is stopped. Accordingly, the n quantity of the maximum walking times when one of the n quantity of candidate get-on-and-off places is excluded is generated.

At step S15, the candidate get-on-and-off place selection module 120 finally excludes the excluded virtual get-on-and-off place corresponding to the minimum value of the n quantity of the maximum walking times from the n quantity of virtual get-on-and-off places. The maximum walking time when one of the n quantity of virtual get-on-and-off places is excluded may be greater than or equal to the maximum walking time in the n quantity of virtual get-on-and-off places. Regarding the n-1 quantity of virtual get-on-and-off places having the minimum value in the maximum walking times, the excluded virtual get-on-and-off place is a virtual get-on-and-off place that has the least effect on walking time. In the present way, virtual get-on-and-off places with little effect on walking time are excluded until k items out of the n quantity of virtual get-on-and-off places remain.

At step S16, the candidate get-on-and-off place selection module 120 subtracts 1 from n value.

At step S17, the candidate get-on-and-off place selection module 120 determines whether the n value is equal to k.

When the n value has not reached k (S17-No), the candidate get-on-and-off place selection module 120 repeats the steps from S11 to S17.

At step S18, when the n value is k (S17-Yes), the candidate get-on-and-off place selection module 120 selects the n quantity of virtual get-on-and-off places as the k quantity of candidate get-on-and-off places.

The candidate get-on-and-off place selection module 120 selects the k quantity of candidate get-on-and-off places in the same way as described above by excluding a candidate get-on-and-off place with smallest increase in the maximum walking time when excluded from among the n quantity of virtual get-on-and-off places.

Furthermore, when determining n quantity of walking travel times from each in all points within the service area to the n quantity of virtual get-on-and-off places, the candidate get-on-and-off place selection module 120 may put priority to a virtual get-on-and-off place satisfying a specific condition so as not to exclude such in selecting k items from among the n items. For example, in determining the walking time with respect to a virtual get-on-and-off place adjacent to a point of interest (POI) for which the virtual get-on-and-off place may be easily found, the candidate get-on-and-off place selection module 120 may determine the walking time by multiplying the actual walking time by a weight value of less than 1. The POI may be predetermined in consideration of the category, popularity, number of floors, and the like of the corresponding point. To be determined as POI, it may belong to a specific category (e.g., convenience store, bank, franchise store, and the like), has a high degree of awareness (the higher the frequency of search, the higher the awareness), and be on the lower floor which is easily recognized while walking.

In the above exemplary embodiment of the present invention, optimal get-on-and-off places are extracted by selecting k items among the n quantity of virtual get-on-and-off places. However, the present invention is not limited thereto, and a predetermined quantity of get-on-and-off places may be extracted from among the n quantity of virtual get-on-and-off places such that the maximum walking time does not exceed the threshold walking time. At the instant time, the predetermined quantity may be different from k, and may not be limited to a specific number.

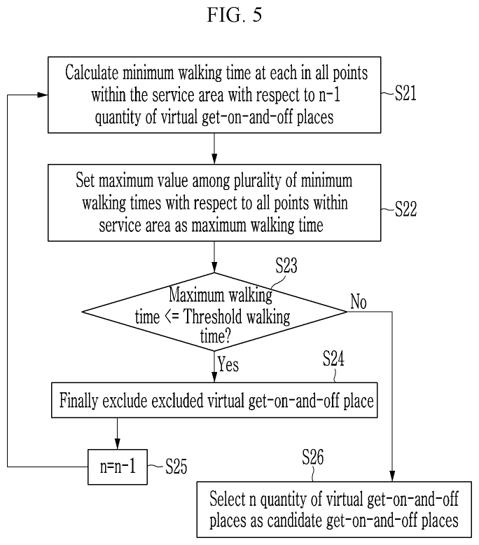

FIG. 5 is a flowchart showing a method for extracting the optimal get-on-and-off place according to an exemplary embodiment of the present invention.

Each step shown in FIG. 5 may be performed by the candidate get-on-and-off place selection module 120.

For example, at step S21, the candidate get-on-and-off place selection module 120 determines the minimum walking time from each in all points within the service area with respect to the n-1 quantity of virtual get-on-and-off places excluding one from the n quantity of virtual get-on-and-off places. The candidate get-on-and-off place selection module 120 may determine the n-1 quantity of walking travel times from each in all points within the service area to the n-1 quantity of virtual get-on-and-off places, and may detect the minimum walking time from the determined n-1 quantity of walking travel times. Accordingly, the minimum walking times are determined for each in all points within the service area.

At step S22, the candidate get-on-and-off place selection module 120 sets a maximum value among the plurality of minimum walking times with respect to all points within the service area as the maximum walking time.

At step S23, the candidate get-on-and-off place selection module 120 determines whether the maximum walking time set at the step S22 does not exceed the threshold walking time.

At step S24, when the maximum walking time does not exceed the threshold walking time (S23-No), the candidate get-on-and-off place selection module 120 finally excludes the virtual get-on-and-off place excluded at the step S21 from among the n quantity of virtual get-on-and-off places.

At step S25, the candidate get-on-and-off place selection module 120 subtracts 1 from the number n, and returns to repeat the step S21.

At step S26, when the maximum walking time exceeds the threshold walking time (S23-No), the candidate get-on-and-off place selection module 120 does not exclude the virtual get-on-and-off place excluded at the step S21 from the n quantity of virtual get-on-and-off places, and selects the n quantity of virtual get-on-and-off places as the candidate get-on-and-off places.

The modules introduced in the operation server 10 may mean a logical portion of a program executed by the operation server 10 to perform a specific function, which may be stored in the memory the operation server 10, and may be processed by a processor of the operation server 10. Such modules may be realized as software or a combination of software. The memory of the operation server 10 stores data related to information, and may include various types of memories such as a high-speed random access memory, a magnetic disk storage device, a flash memory device, and non-volatile memory such as a non-volatile solid-state memory device, and the like.

Accordingly, by automatically presetting vehicle get-on-and-off places, it is possible to accurately provide a transportation service with minimized walking to the user within a faster time.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An operation server comprising:
a road section extraction module configured to extract vehicle road sections accessible by foot;
a filtering module configured to filter extracted vehicle road sections by excluding a vehicle road section in which stopping of a vehicle is not permitted under traffic regulations, from the extracted vehicle road sections; and
a candidate get-on-and-off place selection module configured to select an n quantity of virtual get-on-and-off places allowing getting on-and-off from filtered vehicle road sections, determine a walking time from each in all points of a service area to a closest get-on-and-off place point, set a longest time among walking times of the all points of the service area, as a maximum walking time, and select a predetermined quantity of virtual get-on-and-off places from among the n quantity of virtual get-on-and-off places by use of the selected maximum walking time,
wherein the predetermined quantity is a natural number smaller than a number n.

2. The operation server of claim 1, wherein the candidate get-on-and-off place selection module is configured to:
generate all combinations that are made by selecting a predetermined k quantity of virtual get-on-and-off places from among the n quantity of virtual get-on-and-off places;
determine a plurality of maximum walking times with respect to the all combinations;
select a combination having a minimum walking time from among the plurality of maximum walking times; and
select the k quantity of virtual get-on-and-off places of a selected combination as candidate get-on-and-off places.

3. The operation server of claim 1, wherein the candidate get-on-and-off place selection module is configured to:
with respect to all of the n quantity of virtual get-on-and-off places, set a maximum value among a plurality of minimum walking times with respect to all points within the service area when excluding one virtual get-on-and-off place from the n quantity of virtual get-on-and-off places, as the maximum walking time, to generate n quantity of maximum walking times; and
exclude an excluded one virtual get-on-and-off place corresponding to a minimum value of the n quantity of maximum walking times.

4. The operation server of claim 3, wherein the candidate get-on-and-off place selection module is configured to exclude the virtual get-on-and-off place and subtract 1 from the number n.

5. The operation server of claim 4, wherein the candidate get-on-and-off place selection module is configured to repeat, until the number n reaches a predetermined k quantity, with respect to all of the n quantity of virtual get-on-and-off places, set a maximum value among the plurality of minimum walking times with respect to the all points within the service area when excluding the excluded one virtual get-on-and-off place from the n quantity of the virtual get-on-and-off places, as the maximum walking time, to generate the n quantity of maximum walking times, and finally exclude the excluded virtual get-on-and-off place corresponding to the minimum value of the n quantity of maximum walking times.

6. The operation server of claim 3, wherein the candidate get-on-and-off place selection module is configured to, when determining the n quantity of walking travel times from each in the all points within the service area to the n quantity of virtual get-on-and-off places, decrease the walking travel time with respect to a virtual get-on-and-off place satisfying a predetermined condition according to a predetermined weight value.

7. The operation server of claim 6, wherein the predetermined condition includes whether a point of interest (POI) is adjacent to the virtual get-on-and-off place.

8. The operation server of claim 7, wherein in determining the walking time with respect to the virtual get-on-and-off place adjacent to the POI, the operation server is configured for determining the walking time by multiplying an actual walking time by a weight value of less than 1.

9. The operation server of claim 1, wherein the candidate get-on-and-off place selection module is configured to:
set a maximum value among a plurality of minimum walking times with respect to all points within the service area when excluding one virtual get-on-and-off place from the n quantity of virtual get-on-and-off places, as the maximum walking time; and
exclude the excluded one virtual get-on-and-off place, and subtract 1 from the number n when the maximum walking time does not exceed a predetermined threshold walking time.

10. The operation server of claim 9, wherein the candidate get-on-and-off place selection module is configured to, when the maximum walking time is longer than the predetermined threshold walking time, select the n quantity of virtual get-on-and-off places including the excluded one virtual get-on-and-off place, as candidate get-on-and-off places.

11. A method of extracting a get-on-and-off place where a vehicle is configured to stop, the method comprising:
extracting, by an operation server, vehicle road sections accessible by foot;
filtering, by the operation server, extracted vehicle road sections by excluding a vehicle road section in which stopping of the vehicle is not permitted under traffic regulations, from the extracted vehicle road sections;
selecting, by the operation server, an n quantity of virtual get-on-and-off places allowing getting on-and-off from filtered vehicle road sections;
determining, by the operation server, a walking time from each in all points of a service area to a closest get-on-and-off place point;
setting, by the operation server, a longest time among walking times of all points of the service area, as a maximum walking time; and
selecting, by the operation server, a predetermined quantity of virtual get-on-and-off places from among the n quantity of virtual get-on-and-off places so that the selected maximum walking time is minimum,
wherein the predetermined quantity is a natural number smaller than a number n.

12. The method of claim 11, wherein the selecting of the predetermined quantity of virtual get-on-and-off places includes:
generating all combinations that are made by selecting k items from among the n quantity of virtual get-on-and-off places;
determining a plurality of maximum walking times with respect to the all combinations;
selecting a combination having a minimum walking time from among the plurality of maximum walking times; and
selecting a k quantity of virtual get-on-and-off places of the selected combination as candidate get-on-and-off places.

13. The method of claim 11, wherein the selecting of the predetermined quantity of virtual get-on-and-off places includes:
setting a maximum value among a plurality of minimum walking times with respect to all points within the service area when excluding one virtual get-on-and-off place from the n quantity of virtual get-on-and-off places, as the maximum walking time, to generate an n quantity of maximum walking times, with respect to all of the n quantity of virtual get-on-and-off places; and
excluding the excluded one virtual get-on-and-off place corresponding to a minimum value of the n quantity of maximum walking times.

14. The method of claim 13, further including excluding the one virtual get-on-and-off place and subtracting 1 from the number n.

15. The method of claim 13, wherein the setting of the maximum value among a plurality of minimum walking times with respect to the all points within the service area when excluding the one virtual get-on-and-off place from the n quantity of virtual get-on-and-off places, as the maximum walking time, to generate the n quantity of maximum walking times, with respect to all of the n quantity of virtual get-on-and-off places, and the excluding of the excluded one virtual get-on-and-off place corresponding to the minimum value of the n quantity of maximum walking times are repeated until the number n reaches a predetermined k quantity.

16. The method of claim 13, wherein the selecting of the k quantity of virtual get-on-and-off places further includes, when determining the n quantity of walking travel times from each in the all points within the service area to the n quantity of virtual get-on-and-off places, decreasing the walking travel time with respect to a virtual get-on-and-off place satisfying a predetermined condition according to a predetermined weight value.

17. The method of claim 16, wherein the predetermined condition includes whether a point of interest (POI) is adjacent to the virtual get-on-and-off place.

18. The method of claim 17, further including:
in determining the walking time with respect to the virtual get-on-and-off place adjacent to the POI, determining the walking time by multiplying an actual walking time by a weight value of less than 1.

19. The method of claim 11, further including:
setting a maximum value among a plurality of minimum walking times with respect to all points within the service area when excluding one virtual get-on-and-off place from the n quantity of virtual get-on-and-off places, as the maximum walking time; and
excluding the excluded one virtual get-on-and-off place, and subtracting 1 from the number n when the maximum walking time does not exceed a predetermined threshold walking time.

20. The method of claim 19, further including, when the maximum walking time is longer than the predetermined threshold walking time, selecting the n quantity of virtual get-on-and-off places including the excluded one virtual get-on-and-off place, as candidate get-on-and-off places.
